(19) United States
(12) Patent Application Publication
(10) Pub. No.: US 2021/0053471 A1
(43) Pub. Date: Feb. 25, 2021

(54) CAR SEAT

(71) Applicant: SUMMER INFANT (USA), INC., Woonsocket, RI (US)

(72) Inventor: Mitchell Shellenberger, Mount Joy, PA (US)

(21) Appl. No.: 17/000,527

(22) Filed: Aug. 24, 2020

Related U.S. Application Data
(60) Provisional application No. 62/890,671, filed on Aug. 23, 2019.

(51) Int. Cl. B60N 2/28

(52) U.S. Cl. CPC B60N 2/2821; B60N 2/2806; B60N 2/2863; B60N 2/2866; B60N 2/2812

(57) ABSTRACT

A car seat configured for attachment to a vehicle seat in a selectable forward facing position or rear-facing position. An example embodiment is a car seat that includes a chassis having a backrest portion coupled to a base portion, a seat portion releasably attached to the base portion, and a release handle coupled to the seat portion for enabling detachment of the seat portion from the base. The seat portion can be detached and used as a stand-alone booster. The car seat includes a tension arm for releasably securing the car seat in a forward-facing position onto a vehicle seat. The car seat can include a belt clamp, configured to be acted on by the tension arm, for releasably securing the car seat in a rear-facing position onto a vehicle seat. The car seat can include a rebound bar that can be retracted or folded into the seat.

### CROSS REFERENCE TO RELATED APPLICATIONS

This application claims benefit from U.S. Provisional Patent Application Ser. No. 62/890,671, filed Aug. 23, 2019, which is incorporated herein by reference in its entirety.

### FIELD OF THE INVENTION

The present invention relates generally to child passenger restraints, and more particularly to a car seat.

### BACKGROUND

Vehicle car seats are required by law in many countries for transporting infants and children below certain age and weight thresholds. Even in countries and states that do not legally require car seats for transporting young children, oftentimes, parents will opt to utilize a car seat to protect their children in the event of an accident or crash. Many car seats have been designed to provide various features, such as, rear-facing attachments and the like. Conventional seating systems have incorporated some such features piecemeal, and thus may present countervailing disadvantages, such as unnecessary weight and bulk, difficulty in attaching and removing the car seat from a vehicle seat, and adjusting the car seat to accommodate a child's growth.

### Terms

The term “LATCH” means Lower Anchors and Tethers for Children belt.

### SUMMARY

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In one aspect, the present invention provides a car seat that can be configured and selectively installed in a forward-facing position or rear-facing position on vehicle car seat. The car seat can include a chassis having a backrest portion coupled to a base portion, and a seat portion releasably attached to the base portion. The seat portion can be detached and utilized as a standalone booster seat. A release handle located on the seat portion can enable detachment of the seat portion from the base portion.

One or more of the following features may be included. A tension arm having a first end pivotally coupled to the backrest portion of the chassis, and a second end of the tension arm releasably attached to a distal end of the base portion. The tension arm can be pivotally raised and lowered in and out of the base portion for releasably securing the car seat to a vehicle seat. When lowered into the base portion, the tension arm can secure one or more vehicle belts into the chassis by retracting the vehicle belts into belt paths on the chassis, and retaining the vehicle belts under the tension arm to prevent the vehicle belts from obstructing installation of the seat portion onto the base portion of the chassis.

A belt path can be included on the backrest portion of the chassis, and the belt path can be configured to receive a vehicle belt or LATCH belt for securing the chassis in a forward-facing position onto a vehicle seat. A belt path can also be disposed on the base portion of the chassis, and the belt path can be configured to receive a vehicle belt or LATCH belt for securing the chassis in a rear-facing position onto a vehicle seat.

The tension arm can be used to releasably clamp a vehicle belt or LATCH belt into the belt path on the backrest portion, and tensioning the belt to secure the chassis in a forward-facing position on a vehicle seat. A belt clamp can be pivotally coupled to the base portion of the chassis. The belt clamp can be configured to be acted on by lowering of the tension arm so that a vehicle belt or LATCH belt can be releasably clamped into the belt path on the base portion, and tensioning the belt to secure the chassis in a rear-facing position on a vehicle seat.

Additional features of the car seat can include the following. An adjustable headrest disposed on an upper region of the backrest. The adjustable headrest can include at least one belt guide configured to receive a vehicle belt for securing a child onto the car seat and vehicle seat. The car seat can be configured as a high-back booster. An attachment mechanism, such as, multiple slots can be disposed on the backrest for attaching an adjustable harness for securing a child in the car seat. The seat portion of the car seat can be a booster seat configured for selectable use as the seat portion of the car seat or as a standalone child seat. The seat portion can include at least one belt guide for receiving a vehicle belt for securing a child to the seat portion and vehicle seat. The base portion of the car seat can be adjustable to compensate for differences in angle and/or shape among various vehicle seats.

The car seat can include a rebound bar located on the base portion. The rebound bar can be selectively deployed by extending the rebound bar to its full length and locking it in place. The rebound bar can provide resistance to any rotation of the car seat arising from an impact (e.g., crash, accident) while the car seat is installed in a vehicle. The rebound bar can be manually retracted into the base portion when not deployed. Alternatively, the rebound bar can be manually folded into the base portion when not deployed.

The car seat can further include an adjustable harness releasably attached to the backrest and to the tension arm. The harness can be configured to move, at least in part, with the raising and lowering of the tension arm to allow access to a belt path for installation of the car seat. The harness can be adjusted by moving the harness shoulder strap guides along the backrest. The harness can also be adjusted by threading the harness shoulder straps though one or more slots on the backrest. The harness can be further adjusted by pulling on harness adjuster webbing near an anchor point. The harness can be tensioned and secured at an adjustable anchor point on the seat. The car seat can be configured for installation as either a rear-facing car seat or a forward-facing car seat. The car seat can also be configured as a high-back booster seat.

The present invention provides many improvements and advantages over existing car seats. For example, in addition to capability of being used as a stand-alone booster seat, the removable car seat bottom improves and simplifies the installation process of the car seat, by providing clear visibility and access to the underlying belt paths once the seat bottom is removed from the car seat. This configuration alleviates the need for a user to route vehicle belts through holes in the car seat or under soft goods. Further advantages are provided by the tension arm which alleviates a user's struggle to tension vehicle belts around the car seat during installation. The tension arm of the present invention can simply be lowered into a closed position and the car seat will be tightly installed. The tension arm can have an elongated configuration and other physical characteristics, which substantially improve the available leverage for tensioning vehicle belts during both forward-facing and rear-facing installations of the car seat.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The invention will be more fully understood by reference to the detailed description, in conjunction with the following figures, wherein:

FIG. 1 illustrates an exemplary embodiment of a car seat configured in accordance with the present invention.

FIG. 2 illustrates an exemplary embodiment of a car seat separated from a booster seat portion in accordance with an embodiment of the present invention.

FIG. 3 illustrates an exemplary embodiment of a car seat without a booster seat portion in accordance with an embodiment of the present invention.

FIG. 4 illustrates tensioning and latching features of the car seat in accordance with embodiments of the present invention.

FIG. 5 illustrates an exemplary embodiment of a car seat in a forward-facing configuration in accordance with an embodiment of the present invention.

FIG. 6 illustrates an exemplary embodiment of a car seat in a rear-facing configuration in accordance with an embodiment of the present invention.

FIGS. 7A and 7B illustrate an exemplary car seat having a harness for use with an embodiment of the present invention.

FIG. 8 illustrates an exemplary car seat with a harness configuration and raised tension arm for use with an embodiment of the present invention.

FIG. 9 illustrates an exemplary embodiment of a high-back booster seat configured in accordance with an embodiment of the present invention.

FIGS. 10A-10F illustrate an exemplary car seat having a rebound bar configured in accordance with an embodiment of the present invention.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

Generally, in various embodiments, the present invention provides a car seat that can be configured for attachment to a vehicle seat in a variety of orientations and installations. For example, in an embodiment, the car seat can include features that allow installation of the car seat onto a vehicle seat in a forward-facing position or rear-facing position. In an embodiment, a seat portion of the car seat can be a detachable booster seat that can be used as a standalone child seat.

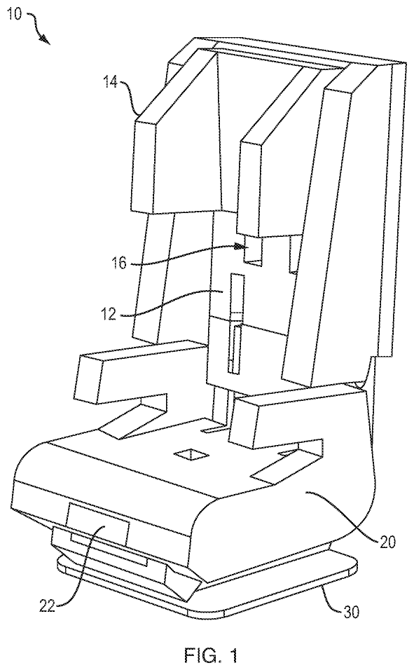

Referring to FIG. 1, in an embodiment, the present invention provides a car seat 10 that in various embodiments can be configured for use as a front-facing car seat, rear-facing car seat, high-back booster seat, or standalone no-back booster seat. The car seat 10 can include a backrest portion 12 and a base portion 30. The backrest portion 12 and base portion 30 can be coupled together by fastening mechanisms, or the two portions can be integrated as a single chassis. The Figures in this specification depict a single chassis configuration, but it should be understood that this is a non-limiting exemplary embodiment and other configurations are within the scope of the present invention.

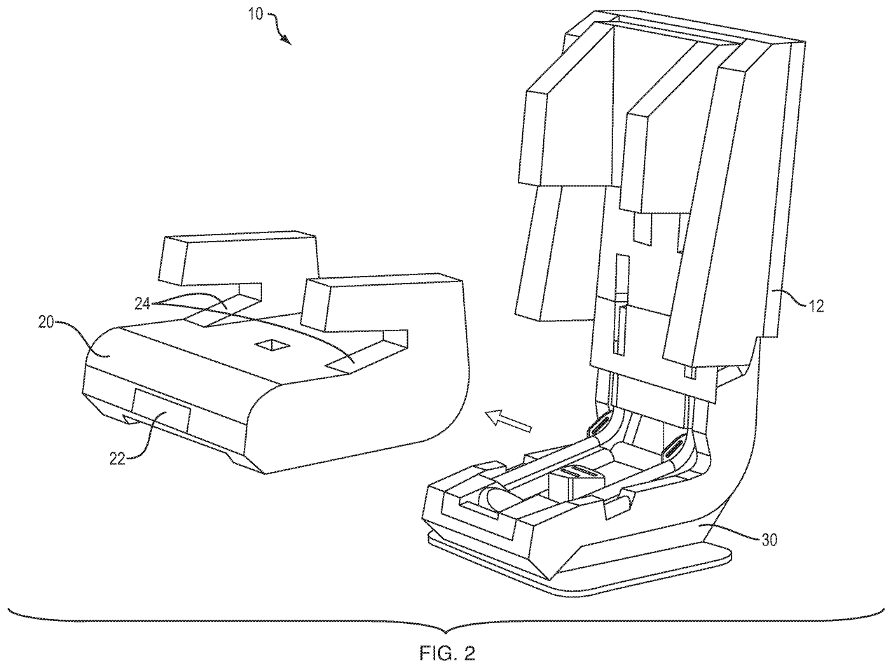

Referring also to FIG. 2, in an embodiment, the car seat 10 can include a seat portion 20 that can be releasably attached to the base portion 30. A release handle 22 can be disposed on the seat portion 20 to enable detachment of the seat portion 20 from the base portion 30. In an embodiment, the seat portion 20 can be a booster seat that can be detached from the base 30, and further used as a standalone child seat. The booster seat 20 can include at least one vehicle belt guide 24 across which a vehicle belt (e.g., standard safety belt) can be passed and tightened to secure a child onto the booster seat 20 and underlying vehicle seat.

In an embodiment, the base portion 30 of the car seat 10 can be configured to adjustably fit a variety of vehicle seats. The base 30 can include a bottom surface that is contoured to bridge a vehicle seat bight, and snuggly fit against a vehicle seat (not shown). Moreover, in an embodiment, the base 30 can include at least one adjustable member, such as, an angle-adjusting foot to compensate for variations in the shape of vehicle seats.

In various embodiments, the car seat 10 can include various features and accessories, such as, an adjustable headrest 14 disposed on an upper region of the backrest 12, and an attachment mechanism, such as, multiple slots 16 disposed on the backrest 12 for attaching an adjustable harness for securing a child in the car seat 10.

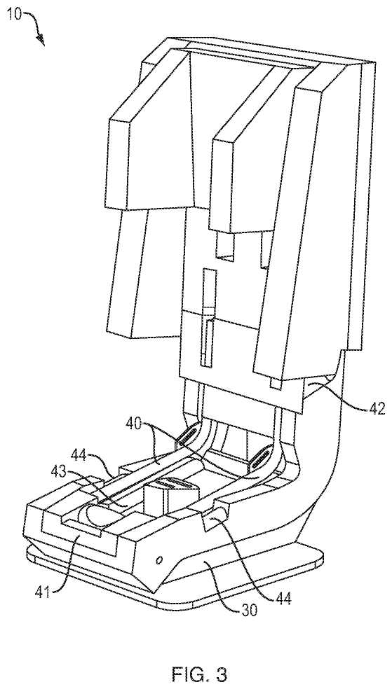

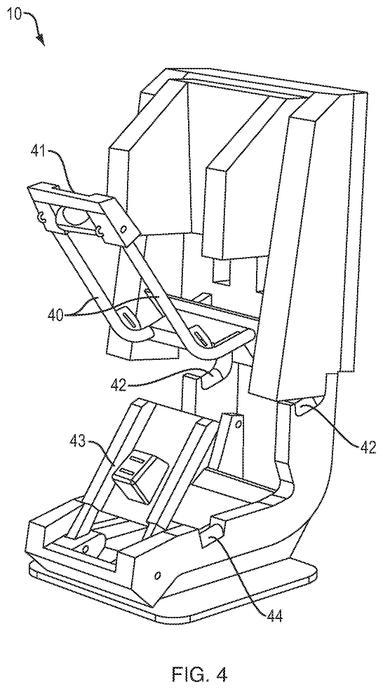

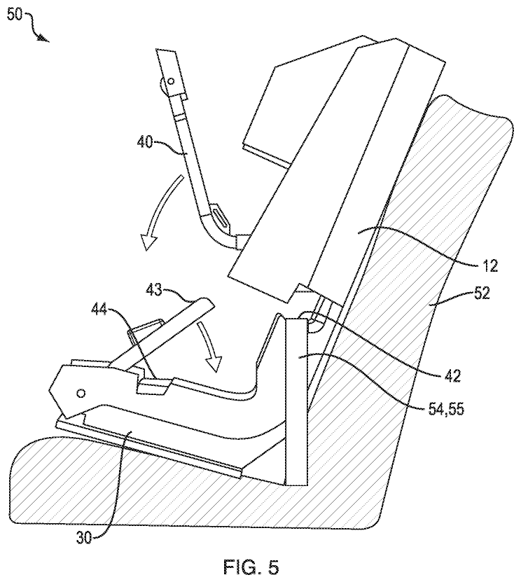

Referring to FIGS. 3, 4, 5 and 6, in an embodiment, a belt path 42 can be disposed on the backrest portion 12 of the car seat chassis 10. The belt path 42 can be configured to receive a vehicle belt 54 or LATCH belt 55 for securing the chassis 10 in a forward-facing position onto a vehicle seat 52 as shown in FIG. 5. Moreover, another belt path 44 can be disposed on the base portion 30 of the chassis 10. The belt path 44 can be configured to receive a vehicle belt 54 or LATCH belt 55 for securing the car seat chassis 10 in a rear-facing position onto a vehicle seat 52 as shown in FIG. 6.

In an embodiment, at least one belt tensioning mechanism can be located, at least partially, on the base 30 beneath the seat portion 20, and access to the mechanism can be obtained by removal of the seat portion 20 from the base 30. For example, in an embodiment, the car seat chassis 10 can include a tension arm 40 having one end pivotally attached to the backrest portion 12 of the car seat chassis 10. An opposite end of the tension arm 40 can be releasably secured to a distal end of the base portion 30. The tension arm 40 can be pivotally raised and lowered in and out of the base 30. The tension arm 40 can include two arm segments and a handle 41 that can house a release and locking device. The tension arm 40 can be used to releasably clamp a vehicle belt 54 or LATCH belt 55 into the belt path 42, and tension the belt 54 to secure the chassis 10 in a forward-facing position on a vehicle seat 52 as shown in FIG. 5.

Moreover, in an embodiment, the car seat chassis 10 can include a second belt tensioning mechanism, such as, belt clamp 43 that can be pivotally attached to the base 30 of the chassis 10. The belt clamp 43 can be utilized for releasably clamping a vehicle belt 54 or LATCH belt 55 into the belt path 44 on the base 30, and tensioning the belt 54 to secure the chassis 10 in a rear-facing position on a vehicle seat 52 as shown in FIG. 6. In an embodiment, the belt clamp 43 can be clamped down onto the belt path 44 by lowering the tension arm 40 onto the belt clamp 43.

Referring to FIG. 5, during a forward-facing installation of the car seat chassis 50, the tension arm 40 is raised upwards to expose the belt path 42. A vehicle belt 54 (or LATCH belt) can then be passed across the belt path 42 and buckled to the vehicle seat 52. Once any slack in the vehicle belt 54 is removed by pulling the belt 54 to position the car seat against both the vehicle seat bottom portion and backrest portion of the vehicle seat 52, the tension arm 40 can be lowered into the base 30 and clamped down on the vehicle belt 54. This action forces the vehicle belt 54 into the belt path 42 in a convoluted configuration (i.e., from the vehicle seat, over the belt guide and belt path 42, under the tension arm 100, over the other belt guide, and back down to the vehicle seat) that tensions the chassis 50 into the vehicle seat 52. During a forward-facing installation, the belt clamp 43 can remain in the down/lowered position in the base 30 and is not involved in securing the chassis 50 to the vehicle seat 52. Once the car seat chassis 50 is installed, the seat portion 20 can be attached and secured to the base 30 of the chassis 50.

Referring to FIG. 6, during a rear-facing installation of the car seat chassis 60, the tension arm 40 is raised upwards allowing the belt clamp 43 to then be raised to expose the belt path 44. A vehicle belt 54 (or LATCH belt) can then be passed across the belt path 44 and buckled to the vehicle seat 52. Once any slack in the vehicle belt 54 is removed by pulling the belt 54 to position the chassis 60 against both the vehicle seat bottom portion and backrest portion 12 of the vehicle seat 52, the tension arm 40 can be lowered onto the belt clamp 43, which in turn, lowers the belt clamp 43 into the base 30 and clamping down on the vehicle belt 54. This action forces the vehicle belt 54 into the belt path 44 in a convoluted configuration (i.e., from the vehicle seat, over the belt guide and belt path 44, under the belt clamp 43, over the other belt guide, and back down to the vehicle seat) that tensions the chassis 60 into the vehicle seat 52. Once the car seat chassis 60 is installed, the seat portion 20 can be attached and secured to the base 30 of the chassis 60.

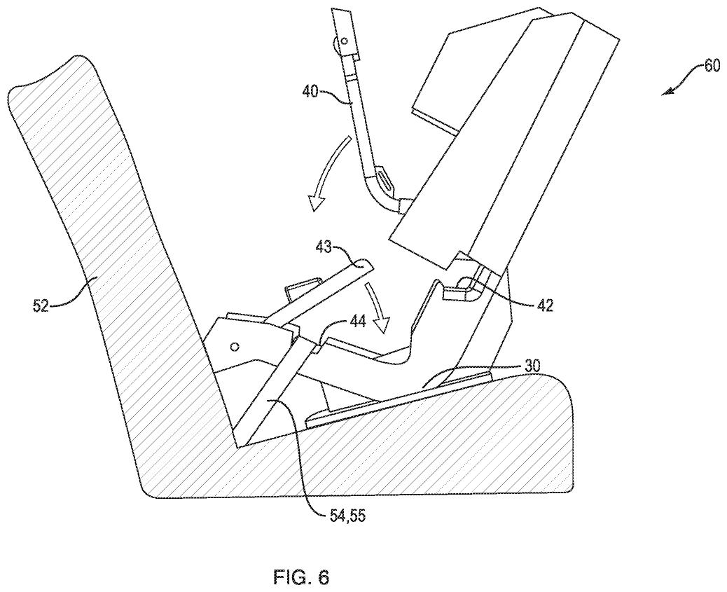

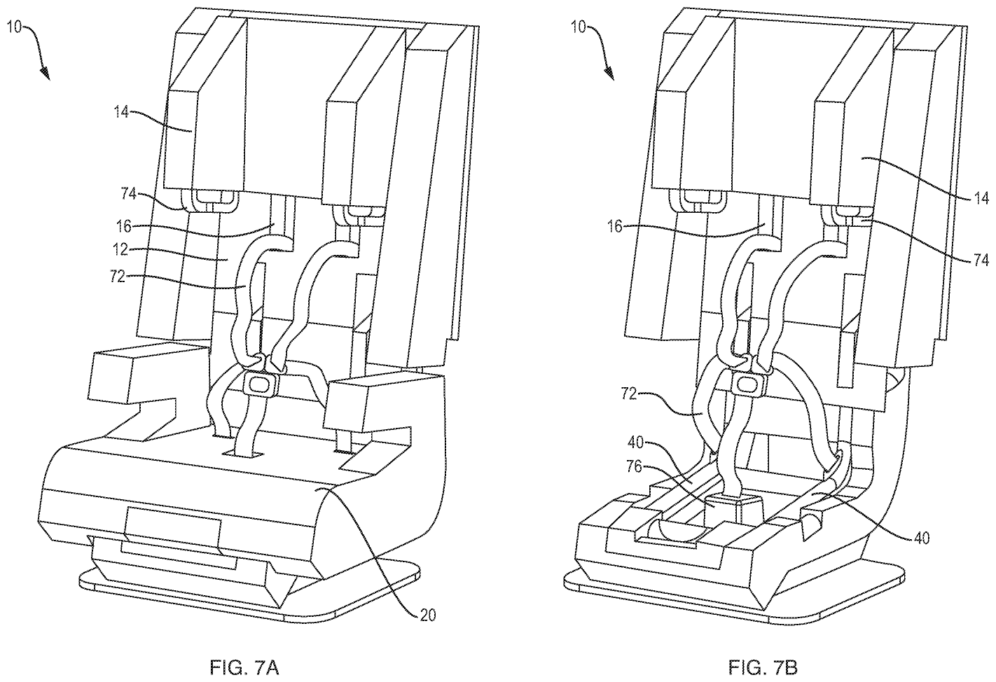

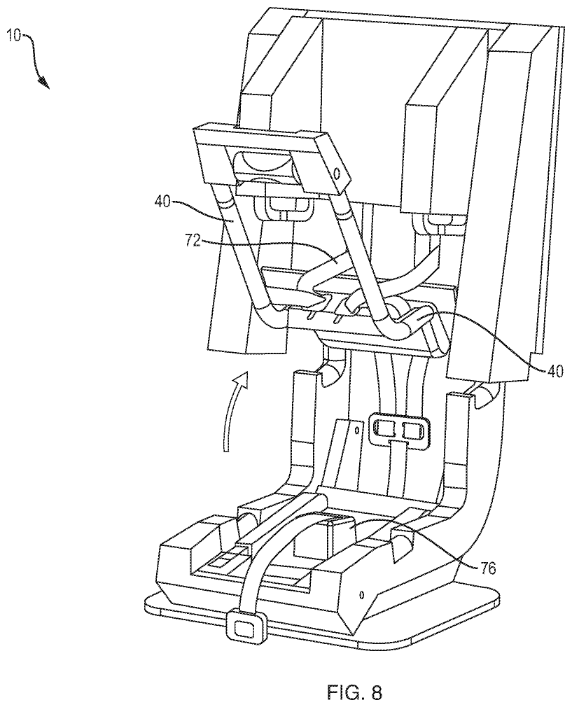

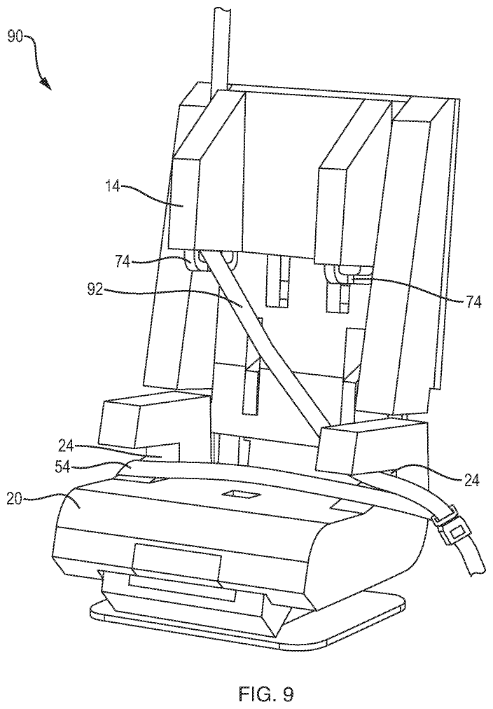

Referring to FIGS. 7A and 7B, exemplary views of the car seat with and without the booster seat 20 are shown respectively. In an embodiment, the car seat 10 can include an adjustable headrest 14 having one or more belt guides 74, which can each receive a vehicle shoulder belt. This design feature permits the car seat to be configured as a high-back belt positioning booster seat as shown in FIG. 9.

In an embodiment, the car seat chassis 10 can include an adjustable harness 72, such as a five-point harness, for securing a child in the car seat. The harness 72 can include shoulder straps and waist straps that can be adjusted to accommodate children of varying sizes. In an embodiment, the shoulder strap portions of the harness 72 can be adjusted and releasably attached to the backrest 12 through one or more slots 16 or belt guides, and the waist strap portions of the harness 72 can be releasably attached to the tension arm 40. The harness 72 can be further adjusted by pulling on harness adjuster webbing near an anchor point. The harness 72 can include a chest clip to position the harness 72 around a child. The harness 72 may also include an adjustable crotch belt that couples the harness to an adjustable anchor 76 on the base 30. In an embodiment, the harness 72 can be tensioned and secured at the adjustable anchor 76.

Referring also to FIG. 8, in an embodiment, the car seat 10 can be configured so that the seat 20 can be removed from the car seat 10 without having to remove the harness 72. The waist strap portions of the harness 72 can be attached to the tension arm 40, so when the tension arm 40 is raised to install the car seat, the waist strap portion of the harness 72 can also be raised out of the way to allow clear access to the belt path for removal and/or installation of the car seat in a vehicle.

Referring to FIG. 9, in an embodiment, the car seat 90 can be configured as a high-back booster seat. For example, vehicle belts, such as shoulder belt 92 and lap belt 54, can be utilized to secure a child and the booster seat 20 onto a vehicle seat. Specifically, the vehicle shoulder belt 92 can be passed along an outer surface of the headrest 14 and threaded through the shoulder belt guide 74, and then across a child's torso, through belt guide 24 and secured onto the vehicle seat. Similarly, vehicle belt 54 can be passed through one belt guide 24 and across a child's lap, and through the opposite belt guide 24 and secured onto the vehicle seat. In an embodiment, the vehicle shoulder belt 92 and vehicle lap belt 54 can be a single vehicle belt assembly. In such a configuration, the harness 72 is not utilized and may be stored, for instance, behind the soft goods (not shown) on the backrest 12.

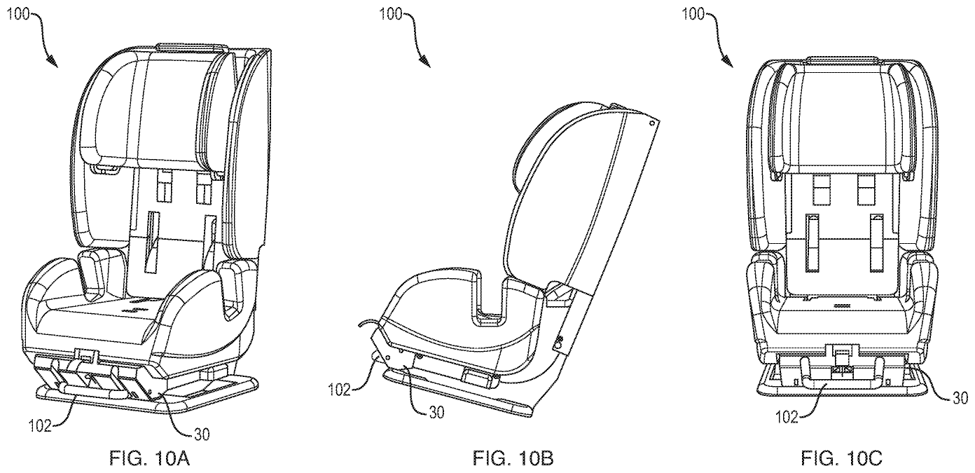

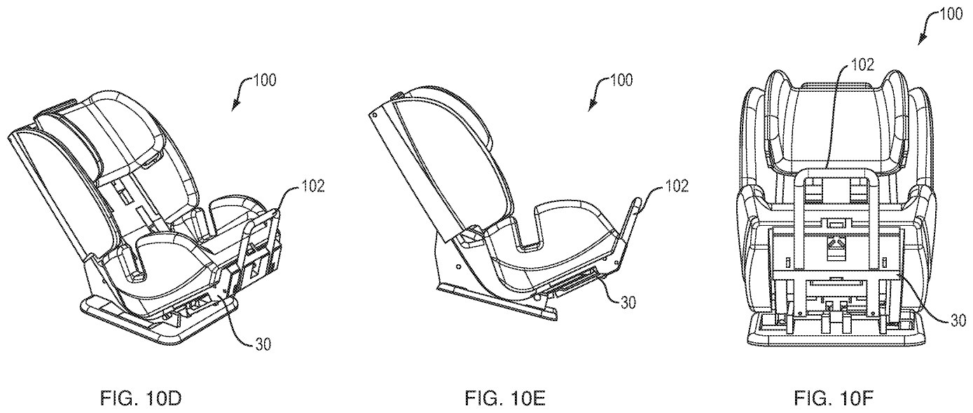

Referring to FIGS. 10A-10F, in an embodiment, the car seat 100 can include a rebound bar 102 that functions to reduce the extent to which the car seat 100 can rotate after a sudden impact in the event of a crash. The rebound bar 102 can be part of or located on the base portion 30. The rebound bar 102 can be selectively deployed by manually extending the rebound bar 102 to its full length and locks in place. In an embodiment, the rebound bar 102, when not in use, can be manually retracted into the base 30. In other embodiments, the rebound bar 102 can be configured to fold into the base 30 when not in use. In operation, typically when the car seat 100 is installed in a rear-facing position, the rebound bar 102 can be extended and locked in place as shown in FIGS. 10D-10F.

While example embodiments have been particularly shown and described, it will be understood by those skilled in the art that various changes in form and details may be made therein without departing from the scope of the embodiments encompassed by the appended claims. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

What is claimed is:

1. A car seat comprising:
a chassis having a backrest portion coupled to a base portion;
a seat portion releasably attached to the base portion, the seat portion further configured for use as a standalone booster seat; and
a release handle coupled to the seat portion and enabling detachment of the seat portion from the base portion.

2. The car seat of claim 1, further comprising a tension arm having a first end pivotally coupled to the backrest portion and a second end of the tension arm releasably secured to a distal end of the base portion, the tension arm configured to be pivotally raised and lowered in and out of the base portion for releasably securing the car seat to a vehicle seat.

3. The car seat of claim 2, wherein the tension arm, when lowered into the base portion, secures at least one vehicle belt into the chassis by retracting the at least one vehicle belt into the chassis and retaining the vehicle belt under the tension arm.

4. The car seat of claim 2, further comprising a belt path disposed on the backrest portion, the belt path configured to receive a vehicle belt for securing the chassis in a forward-facing position onto a vehicle seat.

5. The car seat of claim 4, wherein the tension arm is configured for releasably clamping the vehicle belt into the belt path on the backrest portion and tensioning the belt to secure the chassis in a forward-facing position onto a vehicle seat.

6. The car seat of claim 2, further comprising a belt path disposed in the base portion, the belt path configured to receive a vehicle belt for securing the chassis in a rear-facing position onto a vehicle seat.

7. The car seat of claim 6, wherein the chassis further comprises a belt clamp pivotally coupled to the base portion, the belt clamp configured to be acted on by the tension arm, for releasably clamping the vehicle belt into the belt path on the base portion and tensioning the belt to secure the chassis in a rear-facing position onto a vehicle seat.

8. The car seat of claim 1, further comprising an attachment mechanism or plurality of slots on the backrest for attaching an adjustable harness for securing a child in the car seat.

9. The car seat of claim 8, wherein the adjustable harness is releasably attached to the backrest portion or an anchor point in the seat and the tension arm, the harness configured to move at least in part with the tension arm to allow access to a belt path for installation of the car seat.

10. The car seat of claim 1, further comprising a selectively deployable rebound bar disposed on the base portion and configured to provide resistance to any rotation of the car seat arising from an impact while the car seat is installed in a vehicle.

11. The car seat of claim 10, wherein the rebound bar is configured to manually retract into the base portion when not deployed.

12. The car seat of claim 10, wherein the rebound bar is configured to manually fold into the base portion when not deployed.

13. The car seat of claim 1, wherein the car seat is configured for installation as either a rear-facing car seat or a forward-facing car seat.

14. The car seat of claim 1, wherein the car seat is configured as a high-back booster seat.
